(19) United States
(12) Patent Application Publication
(10) Pub. No.: US 2025/0364608 A1
(43) Pub. Date: Nov. 27, 2025

(54) Subsea Christmas Tree Comprising a Control and Battery Module and Related Method

(71) Applicant: FMC Kongsberg Subsea AS, Kongsberg (NO)

(72) Inventors: Heyn H Magnus, Kongsberg (NO); Christian Meum, Kongsberg (NO); Vidar Nicolaysen, Kongsberg (NO)

(21) Appl. No.: 18/872,737

(22) PCT Filed: Jun. 20, 2023
(86) PCT No.: PCT/EP2023/066673

§ 371 Date: Dec. 6, 2024

(30) Foreign Application Priority Data
Jun. 20, 2022 (NO) 20220697

(51) Int. Cl. H01M 10/42; E21B 33/035; E21B 34/04; E21B 41/00; H01M 50/204; H01M 50/251

(52) U.S. Cl. CPC H01M 10/425; E21B 33/0355; E21B 34/04; E21B 41/0007; H01M 50/204; H01M 50/251; H01M 2220/10

(57) ABSTRACT

A subsea hydrocarbon Christmas tree (400) comprising a control and battery module (100) for controlling electrically actuated valves (200) is described. The control and battery module has first and second subsea electronics modules (110A, 110B) forming a redundant pair, wherein each subsea electronics module is configured for receiving electric power provided from a top-side power supply (300) to operate the valves (200), and a plurality of power back-up battery pack modules (120A, 120B, 120C). The power back-up battery pack modules comprises: a first battery pack module (120A) which is connectable to the first subsea electronics module to provide back-up electric power to the first subsea electronics module should power from the top-side power supply be interrupted; a second battery pack module (120B) which is connectable to the second subsea electronics module to provide back-up electric power to the second subsea electronics module should power from the top-side power supply be interrupted; and at least one additional battery pack module (120C) which is connectable to at least one of the first and the second subsea electronics modules (110A, 110B). A related method is also described (FIG. 2)

### FIELD OF THE INVENTION

The present invention relates to a subsea hydrocarbon Christmas tree comprising a control and battery module and a related method. In particular, the present invention relates to a Christmas tree comprising a control and battery module for controlling electrically actuated valves, each valve being actuated by an electric motor, and means for providing back-up electric power.

### BACKGROUND

Within the art of subsea hydrocarbon production, it has been suggested to use all-electric systems for operating valves in Christmas trees. Providing reliable and cost-effective back-up power in such systems is a challenge.

GB2364396A discloses an electric actuator system for subsea environment. The actuator contains at least one electric motor, at least one electrical storage unit (rechargeable battery), and a control unit. The control unit contains switching means for controlling the power to the motor and an intelligent processor which receives signals relating to the state of the electrical storage unit, and of an external power supply, and preferably external information and/or control signals. The controller connects the motor to a selected power source to move the actuator to a desired position according to the received signals. In the event of loss of external power, the controller can allow the actuator to continue to function as long as the storage unit has adequate power, thus preventing unnecessary shutdowns.

US2005/0179263A1 discloses a system for generating an electrical power output from a subsea installation, the subsea installation comprising at least one flowline, the system comprising a turbine operatively connected to the flowline, the turbine being rotatable by fluid flowing through the flowline, and the turbine generating the electrical power output when the turbine is rotated.

EP0984133A1 discloses a valve actuation module having a plurality of valve actuators for operating respective valve elements via a rotary drive. The module is arranged to receive primary power and control signals from an external source in order to operate the valves. Each actuator has its own back-up power means comprising a self-contained electrical storage unit providing a secondary power source, a motor driven by the electrical storage unit, and control means to detect the interruption of the primary power and cause the valve element to be moved into a safe position using the secondary power.

### SUMMARY OF THE INVENTION

With the abovementioned challenge in mind, and according to a first aspect, the present disclosure provides a subsea hydrocarbon Christmas tree comprising a control and battery module for controlling electrically actuated valves, each valve being actuated by an electric motor. The control and battery module comprises first and second subsea electronics modules forming a redundant pair of subsea electronics modules. Consequently, the first and second subsea electronics modules provide dual modular redundancy (DMR), i.e. provide redundancy in case one of the subsea electronics modules should fail.

Each subsea electronics module is configured for receiving electric power provided from a top-side power supply to operate the valves.

The control and battery module further comprises a plurality of power back-up battery pack modules, comprising:
a first battery pack module which is connectable to the first subsea electronics module to provide back-up electric power to the first subsea electronics module should power from the top-side power supply be interrupted;
a second battery pack module which is connectable to the second subsea electronics module to provide back-up electric power to the second subsea electronics module should power from the top-side power supply be interrupted; and
at least one additional battery pack module which is connectable to at least one of the first and the second subsea electronics modules.

Consequently, should power from the top-side power supply be interrupted, the first battery pack module can be connected to the first subsea electronics module, and the second battery pack module can be connected to the second subsea electronics module, thus maintaining a powered redundant pair of subsea electronics modules, thus allowing the control and battery module to effectuate a redundantly powered shut-down or closing of the Christmas tree.

The at least one additional battery pack module, by virtue of being connectable to at least one of the first and the second subsea electronics modules, may form a back-up battery pack module for the first and/or the second subsea electronics module and, in particular, may form a redundant pair of power back-up battery pack modules together with the first and/or the second battery pack module.

The at least one additional battery pack module may be connectable to both the first and the second subsea electronics modules, thus allowing the at least one additional battery pack module to form a redundant pair of power back-up battery pack modules together with either one of the first and the second battery pack modules. Allowing the at least one additional battery pack module to be shared between the first and the second subsea electronics modules provides for a reliable yet cost-effective back-up power system.

The at least one additional battery pack module may comprise a third battery pack module which is connectable to the first subsea electronics module to form a redundant pair of power back-up battery pack modules for the first subsea electronics module together with the first battery pack module. The at least one additional battery pack module may also comprise a fourth battery pack module which is connectable to the second subsea electronics module to form a redundant pair of power back-up battery pack modules for the second subsea electronics module together with the second battery pack module.

The third battery pack module may be connectable exclusively to the first subsea electronics module to form a redundant pair of power back-up battery pack modules exclusively for the first subsea electronics module together with the first battery pack module. The fourth battery pack module may be connectable exclusively to the second subsea electronics module to form a redundant pair of power back-up battery pack modules exclusively for the second subsea electronics module together with the second battery pack module.

However, the second and fourth battery pack modules may be connectable also to the first subsea electronics module. This will allow the second and fourth battery pack modules, although primarily designated to provide back-up power to the second subsea electronics module, to act as additional back-up power sources for the first subsea electronics module in addition to the first and third battery pack modules.

Likewise, the first and third battery pack modules may be connectable also to the second subsea electronics module, thus allowing the first and third battery pack modules to act as additional back-up power sources for the second subsea electronics module in addition to the second and fourth battery pack modules.

Each of said plurality of battery pack modules may comprise a battery package comprising battery cells and, for each subsea electronics module to which the battery pack module is connectable, an on/off switch configured to connect the battery cells to the respective subsea electronics module. Each of said plurality of battery pack modules additionally or alternatively comprise an electric fuse arranged between the battery cells and the respective subsea electronics module.

Each of said first and second subsea electronics modules may comprise electric motor drives configured for powering and controlling said electric motors to operate the valves.

The first and second subsea electronics modules and the plurality of battery pack modules may be arranged in a common retrievable container in the Christmas tree, thus allowing the control and battery module to be replaced in a single operation, e.g. using an ROV. Alternatively, the modules may be arranged in separate, retrievable containers and be individually retrievable.

Sub-sections of said retrievable containers, in particular sub-sections containing electrical wiring, may be filled with dielectric fluid and pressure compensated. Other sub-sections of the containers may be open to ambient seawater.

Each of the plurality of battery pack modules may be contained in a separate battery pack module sub-container, e.g. holding sea-level pressure, i.e. approximately 1013 hPa.

Likewise, each of said first and second subsea electronics modules may be contained in a separate subsea electronics module sub-container holding sea-level pressure. This will provide additional protection for the battery pack and subsea electronics modules should the retrievable container be damaged. The sub-containers may be filled with dry nitrogen.

According to a second aspect, the present disclosure provides a method of providing back-up electric power to a subsea hydrocarbon Christmas tree according to the first aspect when electric power provided from the top-side power supply to the first and second subsea electronics modules is interrupted.

The method comprises the steps of:
connecting the first battery pack module to the first subsea electronics module to energise the first subsea electronics module;
connecting the second battery pack module to the second subsea electronics module to energise the second subsea electronics module, and
reserving the at least one battery pack module as a back-up battery pack module for at least one of the first battery pack module and the second battery pack module; and
if any one of the first battery pack module and the second battery pack module fails, connecting the at least one additional battery pack module to the subsea electronics module connected to the failed battery pack module to energise that subsea electronics module.

Consequently, as long as power from the top-side power supply is maintained, one of the first and the second subsea electronics module will be the active subsea electronics module controlling the electrically actuated valves and the other subsea electronics module will stand by as a redundant pair, ready to be activated if the presently active subsea electronics module malfunctions.

However, should power from the top-side power supply be interrupted, the first battery pack module may be activated to energise the first subsea electronics module and the second battery pack module may be activated to energise the second subsea electronics module, thus allowing the control and battery module to effectuate a shut-down or closing of the subsea Christmas tree with one of the first and the second subsea electronics module acting as the active subsea electronics module, i.e. controlling the electrically actuated valves, and the other acting as the back-up subsea electronics module, i.e. being ready to be activated if the presently active subsea electronics module malfunctions.

Should the first battery pack module or the second battery pack module fail to deliver power to the first and second subsea electronics module, respectively, the at least one additional battery pack module is activated to provide power to the subsea electronics module in lieu of the failed first or second battery pack module.

The first and second battery pack module may fail to deliver power due to the battery pack module malfunctioning. In such a scenario the at least one additional battery pack module provides redundancy in the system. Alternatively, the first or second battery pack module may fail in delivering power due to its battery package becoming depleted. In such a case the at least one battery pack module may be activated to prolong operational life of the system.

As previously stated, the first battery pack module, in addition to being connectable to the first subsea electronics module, may also be connectable to the second subsea electronics module, and the second battery pack module, in addition to being connectable to the second subsea electronics module, may also be connectable to the first subsea electronics module. This will allow both the first and second battery pack module to act as a back-up modules for the first and the second subsea electronics module, respectively, when electric power provided from the top-side power supply to the first and second subsea electronics modules is interrupted. Alternatively, the first battery pack module may be connected exclusively to the first subsea electronics module and the second battery pack module may be connected exclusively to the second subsea electronics module when electric power provided from the top-side power supply to the first and second subsea electronics modules is interrupted. Also, one of said additional battery pack modules may be reserved as a back-up battery pack module exclusively for the first battery pack module, and another of said additional battery pack modules may be reserved exclusively as a back-up battery pack module for the second battery pack module, thus providing two redundant pairs of back-up battery pack modules, where each pair is dedicated exclusively to one particular subsea electronics module.

For example, said at least one additional battery pack module may comprise comprises: a third battery pack module which is connectable to the first subsea electronics module and forms a redundant pair of power back-up battery pack modules for the first subsea electronics module; and a fourth battery pack module which is connectable to the second subsea electronics modules and forms a redundant pair of power back-up battery pack modules for the second subsea electronics module, in which case the method may comprise the steps of:
if the first battery pack module fails, connecting the third battery pack module to the subsea electronics module connected to the failed first battery pack module to energise that subsea electronics module; and/or
if the second battery pack module fails, connecting the fourth battery pack module to the subsea electronics module connected to the failed second battery pack module to energise that subsea electronics module.

Above-discussed preferred and/or optional features of each aspect of the invention may be used, alone or in appropriate combination, in the other aspects of the invention.

### DESCRIPTION OF THE DRAWINGS

Following drawings are appended to facilitate the understanding of the invention:

FIG. 1 discloses a hydrocarbon production Christmas tree comprising an embodiment of a control and battery module;

FIG. 2 is a diagram schematically illustrating the functioning and layout of the control and battery module;

FIG. 3 is a detailed diagram schematically illustrating the functioning and layout of a battery pack module of the control and battery module;

FIG. 4 is a diagram schematically illustrating the functioning and layout of a further embodiment of a control and battery module; and

FIG. 5 is a diagram schematically illustrating the functioning and layout of yet a further embodiment of a control and battery module.

In the drawings, like reference numerals have been used to indicate common parts, elements or features unless otherwise explicitly stated or implicitly understood by the context.

### DETAILED DESCRIPTION OF THE INVENTION

In the following, specific embodiments of a control and battery module will be described in more detail with reference to the drawings. However, it is specifically intended that the invention as specified in the following claims is not limited to the embodiments and illustrations contained herein, but includes modified forms of the embodiments including portions of the embodiments and combinations of elements of different embodiments as come within the scope of the claims. It should be appreciated that in the development of any such actual implementation, as in any engineering or design project, numerous implementation-specific decisions must be made to achieve the developer's specific goals, such as compliance with system and/or business related constraints, which may vary from one implementation of the invention to another. Moreover, it should be appreciated that such a development effort might be complex and time consuming, but would nevertheless be a routine undertaking of design, fabrication and manufacture for the skilled person having the benefit of this disclosure.

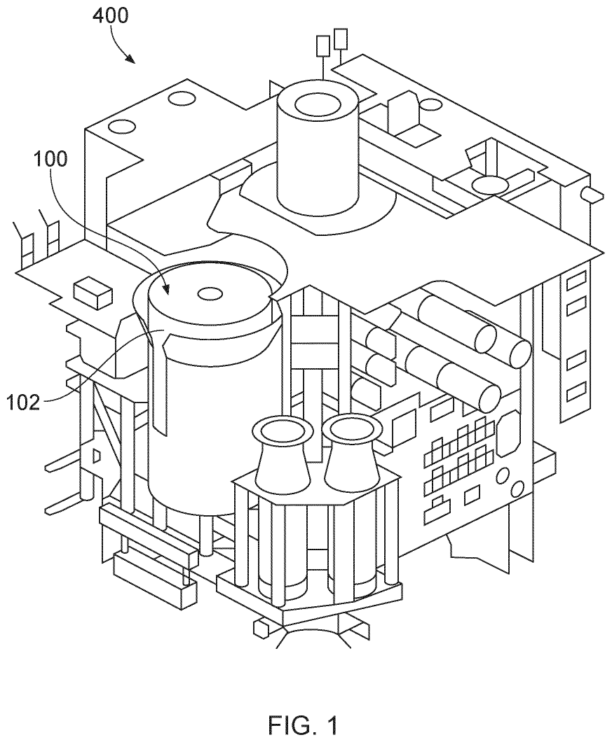

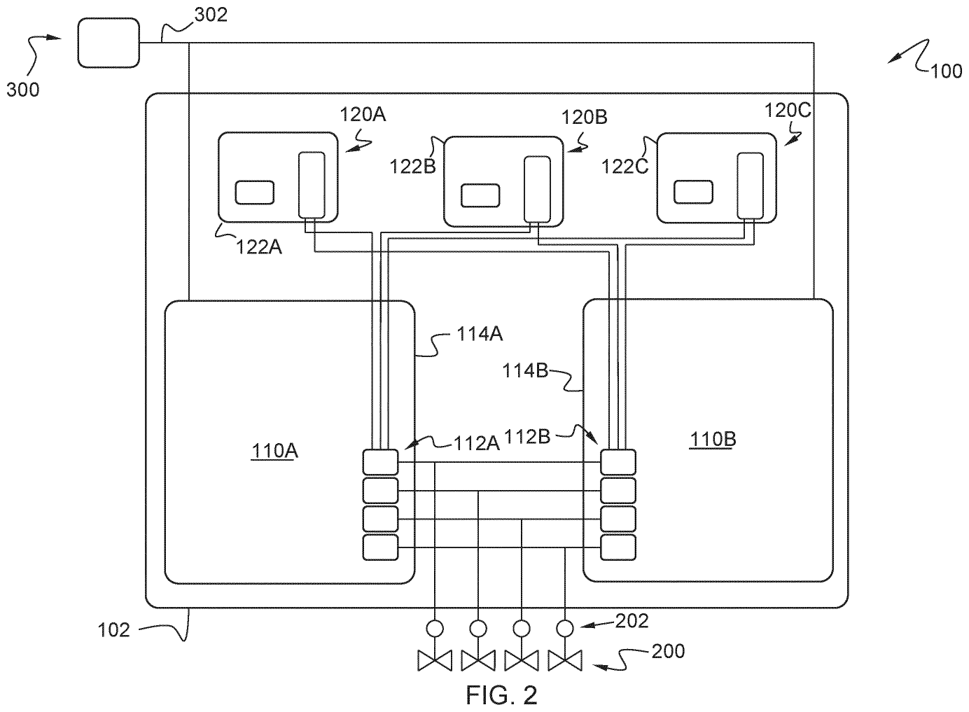

FIG. 1 discloses a subsea hydrocarbon Christmas tree 400 comprising a control and battery module 100 for controlling electrically actuated valves 200 (see FIG. 2) associated with the Christmas tree 400. These valves may typically include a surface-controlled subsurface safety valve, production master and wing valves, annulus master and wing valves, a cross-over valve, chemical injection valves and choke valves.

Each valve 200 is actuated by an electric motor 202.

Referring now to FIG. 2. the control and battery module 100 comprises a first 110A and a second 110B subsea electronics module (SEM) forming a redundant pair. Each subsea electronics module 110A, 110B is configured for receiving electric power provided from a top-side power supply 300 to operate the valves 200. Top-side power is provided to the subsea electronics modules 110A, 110B via an umbilical 302, as is schematically illustrated in FIG. 2.

The control and battery module 100 further comprises a plurality of power back-up battery pack modules 120A, 120B, 120C, comprising:
a first battery pack module 120A which is connectable to the first subsea electronics module 110A to provide back-up electric power to the first subsea electronics module 110A should power from the top-side power supply 300 be interrupted;
a second battery pack module 120B which is connectable to the second subsea electronics module 110B to provide back-up electric power to the second subsea electronics module 110B should power from the top-side power supply 300 be interrupted; and
an additional, third battery pack module 120C which is connectable to the first and the second subsea electronics modules 110A, 110B.

Advantageously, the first battery pack module 120A may also be connectable to the second subsea electronics module 110B and the second battery pack modules 120B may also be connectable to the first subsea electronics module 110A, thus enabling each of the first, second and third battery pack modules 120A, 120B, 120C to be connected to each of the first and second subsea electronics modules 110A, 110B.

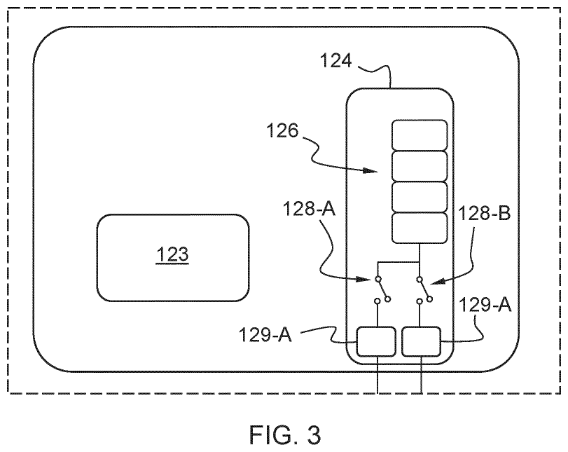

Each of the battery pack modules 120A, 120B, 120C comprises a battery package 124 comprising battery cells 126 and, for each subsea electronics module 110A, 110B to which the battery pack module 120A, 120B, 120C is connectable, an on/off switch 128-A, 128-B configured to control (open and close) the electrical connection between the battery cells 126 and the respective subsea electronics module 110A, 110B (see FIG. 3). Each battery pack module 120A, 120B, 120C also comprises an electric fuse 128-A, 128-B arranged between the battery cells 126 and the respective subsea electronics module 110A, 110B to prevent electrical surge currents emerging from the battery cells 126 from damaging the subsea electronics module 110A, 110B.

In the present embodiment, the control and battery module 100 comprises a retrievable container 102 housing all of the components of the module 100, including the first and second subsea electronics modules 110A, 110B and the plurality of battery pack modules 120A, 120B, 120C. This will allow the control and battery module 100 to be replaced in a single operation, e.g. using an ROV.

Also, each of the battery pack modules 120A, 120B, 120C is contained in a separate battery pack module sub-container 122A, 122B, 122C. Likewise, each of the first and second subsea electronics modules 110A, 110B is contained in a separate subsea electronics module sub-container 214A, 214B. This will provide additional protection for the battery pack and subsea electronics modules should the retrievable container 102 be damaged. The sub-containers 122A, 122B, 122C and 214A, 214B may each hold sea-level pressure allowing the battery pack modules, including associated electrical components, to be kept at atmospheric pressure, thus allowing for use of standard electrical components and battery cells in the battery pack modules.

Each of the first and second subsea electronics modules 110A, 110B comprises electric motor drives 112A, 112B which are configured for powering and controlling the electric motors 202 to operate the valves 200.

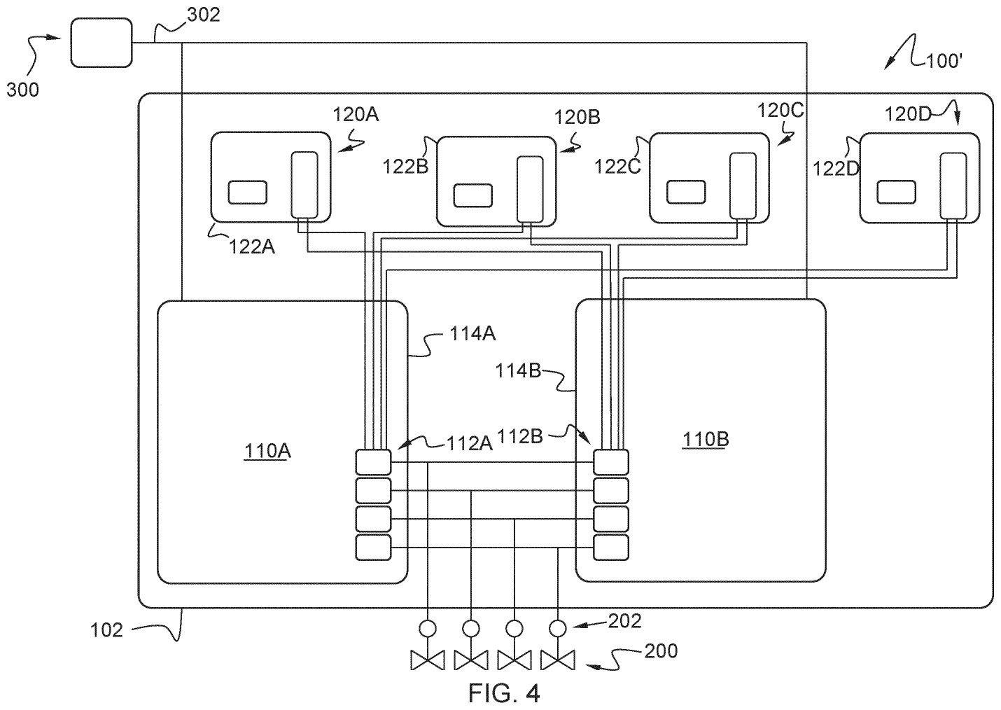

FIG. 4 illustrates an embodiment of a control and battery module 100′ in which the plurality of power back-up battery pack modules comprises an additional, fourth battery pack module 120D which is also connectable to the first and the second subsea electronics modules 110A, 110B, thus allowing each of the first, second, third and fourth battery pack modules to be connected to each of the first and second subsea electronics modules 110A, 110B to provide back-up power.

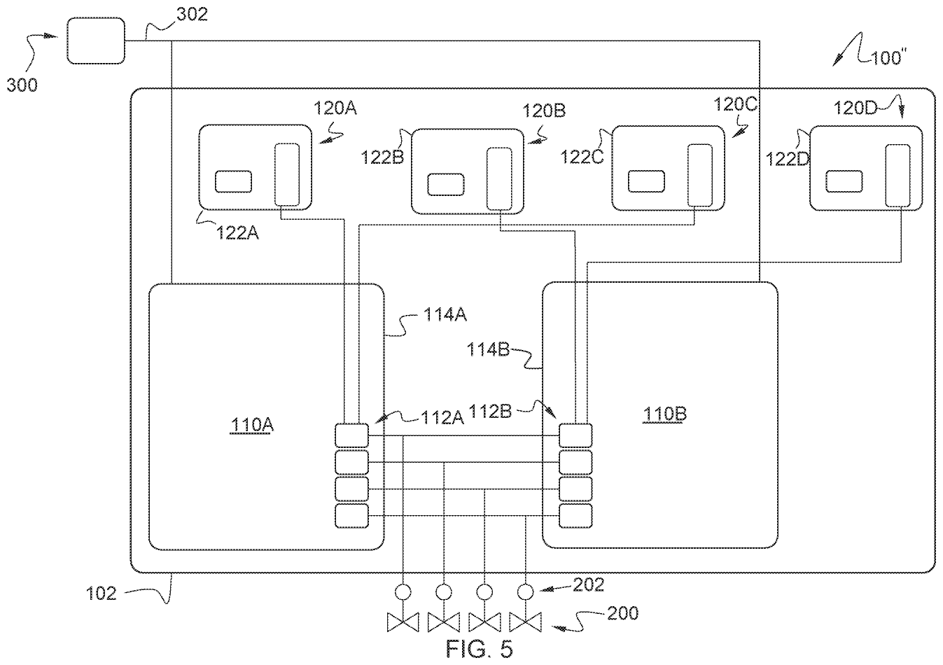

FIG. 5 illustrates an embodiment of a control and battery module 100″ in which the first 120A and third 120C battery pack modules are connectable exclusively to the first subsea electronics module 110A to form a redundant pair of power back-up battery pack modules exclusively for the first subsea electronics module 110A, and the second 120B and fourth 120D battery pack modules and connectable exclusively to the second subsea electronics module 110B to form a redundant pair of power back-up battery pack modules exclusively for the second subsea electronics module 110B.

It is appreciated that certain features of the invention, which, for clarity, have been described above in the context of separate embodiments, may also be provided in combination in a single embodiment. Conversely, various features of the invention, which, for brevity, have been described in the context of a single embodiment, may also be provided separately or in any suitable sub-combination.

In the preceding description, various aspects of the apparatus according to the invention have been described with reference to the illustrative embodiment. For purposes of explanation, specific numbers, systems, and configurations were set forth in order to provide a thorough understanding of the apparatus and its workings. However, this description is not intended to be construed in a limiting sense. Various modifications and variations of the illustrative embodiment, as well as other embodiments of the apparatus, which are apparent to person skilled in the art to which the disclosed subject-matter pertains, may lie within the scope of the present invention as defined by the following claims.

1. A subsea hydrocarbon Christmas tree comprising a control and battery module for controlling a number of electrically actuated valves, each valve being actuated by an electric motor, the control and battery module comprising:
first and second subsea electronics modules forming a redundant pair of subsea electronics modules, each subsea electronics module being configured for receiving electric power from a top-side power supply to operate the valves;
a plurality of power back-up battery pack modules, including:
a first battery pack module which is connectable to the first subsea electronics module to provide back-up electric power to the first subsea electronics module should power from the top-side power supply be interrupted;
a second battery pack module which is connectable to the second subsea electronics module to provide back-up electric power to the second subsea electronics module should power from the top-side power supply be interrupted; and
at least one additional battery pack module which is connectable to at least one of the first and the second subsea electronics modules.

2. The Christmas tree according to claim 1, wherein the first battery pack module is connectable to the second subsea electronics module and the second battery pack module is connectable to the first subsea electronics module.

3. The Christmas tree according to claim 2, wherein said at least one additional battery pack module comprises a third battery pack module which is connectable to the first subsea electronics module and forms a redundant pair of power back-up battery pack modules for the first subsea electronics module, and a fourth battery pack module which is connectable to the second subsea electronics module and forms a redundant pair of power back-up battery pack modules for the second subsea electronics module.

4. The Christmas tree according to claim 1, wherein each of said first and second subsea electronics modules comprises electric motor drives configured for powering and controlling said electric motors to operate the valves.

5. The Christmas tree according to claim 1, wherein the first and second subsea electronics modules and the battery pack modules are arranged in a common retrievable container in the Christmas tree.

6. The Christmas tree according to claim 1, wherein each of said battery pack modules comprises a battery package comprising battery cells and, for each subsea electronics module to which the battery pack module is connectable, an on/off switch configured to control an electrical connection between the battery cells and the respective subsea electronics module.

7. The Christmas tree according to claim 6, wherein each of said battery pack modules comprises an electric fuse arranged between the battery cells and the respective subsea electronics module.

8. The Christmas tree according to claim 1, wherein each of said battery pack modules is contained in a respective battery pack module sub-container.

9. The Christmas tree according to claim 1, wherein each of said first and second subsea electronics modules is contained in a respective subsea electronics module sub-container.

10. A method of providing back-up electric power to the subsea hydrocarbon Christmas tree according to claim 1 when electric power provided from the top-side power supply to the first and second electronics modules is interrupted, the method comprising:
connecting the first battery pack module to the first subsea electronics module to energize the first subsea electronics module;
connecting the second battery pack module to the second subsea electronics module to energize the second subsea electronics module;
reserving the at least one additional battery pack module as a back-up battery pack module for at least one of the first battery pack module and the second battery pack module; and
if any one of the first battery pack module and the second battery pack module fails, connecting the at least one additional battery pack module to the subsea electronics module connected to the failed battery pack module to energize that subsea electronics module.

11. The method according to claim 10, wherein said at least one additional battery pack module comprises a third battery pack module which is connectable to the first subsea electronics module and forms a redundant pair of power back-up battery pack modules for the first subsea electronics module, and a fourth battery pack module which is connectable to the second subsea electronics module and forms a redundant pair of power back-up battery pack modules for the second subsea electronics module, and wherein the method further comprises:
if the first battery pack module fails, connecting the third battery pack module to the subsea electronics module connected to the failed first battery pack module to energize that subsea electronics module; and/or
if the second battery pack module fails, connecting the fourth battery pack module to the subsea electronics module connected to the failed second battery pack module to energize that subsea electronics module.
